(19) United States
(12) Patent Application Publication
(10) Pub. No.: US 2016/0203200 A1
(43) Pub. Date: Jul. 14, 2016

(54) MANAGEMENT APPARATUS, CONTROL METHOD FOR MANAGEMENT APPARATUS, AND STORAGE MEDIUM

(71) Applicant: CANON KABUSHIKI KAISHA, Tokyo (JP)

(72) Inventor: Noritsugu Okayama, Tokyo (JP)

(21) Appl. No.: 14/983,970

(22) Filed: Dec. 30, 2015

(30) Foreign Application Priority Data
Jan. 8, 2015 (JP) 2015-002103

(51) Int. Cl. G06F 17/30; H04L 29/08

(52) U.S. Cl. CPC G06F 17/30575; G06F 17/30374; G06F 17/30371; H04L 67/1095

(57) ABSTRACT

A management apparatus determines, in a case where a setting item of first setting information, requested to be stored in the storage unit, is a setting item of a first type, whether a setting content of the first setting information conflicts with a setting content of second setting information stored in the storage unit. The management apparatus performs control in such a manner that at least: (i) in a case where the setting item of the first setting information is a setting item of a second type, the storage unit stores the first setting information regardless of whether the setting content of the first information conflicts with the setting content of the second setting information, and (ii) in a case where the setting content of the first setting information conflicts with the setting content of the second setting information, storing of the first setting information of which sharing is restricted.

### BACKGROUND

1. Technical Field

The present disclosure relates to a management apparatus, a control method for a management apparatus, and a storage medium.

2. Description of the Related Art

Recently, techniques for synchronizing master data on a server with setting data set in each of a plurality of information processing apparatuses connected to the server through a network, have been proposed. Japanese Patent Application Laid-Open No. 2013-88855 discusses a technique for determining whether a change on the setting data, set in any one of the information processing apparatuses, conflicts with the setting data stored in the server. This conventional technique involves a large processing load imposed on a data synchronization system because conflict check is executed on every piece of setting data registered in the server.

### SUMMARY

At least one embodiment of a management apparatus includes a storage unit configured to store setting information to be used by an information processing apparatus, a reception unit configured to receive a request for causing the storage unit to store the setting information to be used by the information processing apparatus, a determination unit configure to determine, in a case where a setting item of first setting information, requested to be stored in the storage unit, is a setting item of a first type, whether a setting content of the first setting information conflicts with a setting content of second setting information stored in the storage unit, and a control unit configured to perform control in such a manner that: (i) in a case where the setting item of the first setting information is a setting item of a second type different from the first type, the storage unit stores the first setting information regardless of whether the setting content of the first information conflicts with the setting content of the second setting information, (ii) in a case where the determination unit determines that the setting content of the first setting information conflicts with the setting content of the second setting information, storing of the first setting information as a share target in the storage unit is restricted, and (iii) in a case where the determination unit determines that the setting content of the first setting information does not conflict with the setting content of the second setting information, the storage unit stores the first setting information as the share target.

According to other aspects of the present disclosure, one or more additional management apparatuses, one or more control methods, and one or more storage mediums are discussed herein. Further features of the present disclosure will become apparent from the following description of exemplary embodiments with reference to the attached drawings.

### BRIEF DESCRIPTION OF THE DRAWINGS

FIG. 1 is a block diagram illustrating a configuration of a system including a management apparatus and information processing apparatuses.

FIG. 2 is a block diagram illustrating a configuration of a setting value management server.

FIG. 3 is a block diagram illustrating a configuration of a multifunctional peripheral (MFP).

FIG. 4 is a diagram illustrating software configuration modules of the setting value management server and the MFP.

FIG. 5 is a flowchart illustrating a control method for the management apparatus.

FIG. 6 is a flowchart illustrating a control method for the management apparatus.

FIG. 7 is a flowchart illustrating a control method for the information processing apparatus.

FIG. 8 is a flowchart illustrating a control method for the information processing apparatus.

FIG. 9 is a diagram illustrating an example of a user interface (UI) screen displayed on a display unit of the management apparatus.

FIGS. 10A, 10B, and 10C are tables respectively illustrating an example of master data, an example of data in a setting value database (DB) of an MFP 120a, and an example of data in a setting value DB of an MFP 120b.

FIGS. 11A, 11B and 11C are tables respectively illustrating an example of data update request information, an example of master data information in a state where “SYNCHRONIZATION DISABLE FLAG” is ON, and an example of the master data information in a state where “SYNCHRONIZATION DISABLE FLAG” is OFF.

### DESCRIPTION OF THE EMBODIMENTS

An exemplary embodiment of the present disclosure is described with reference to the drawings.

### <Description of System Configuration>

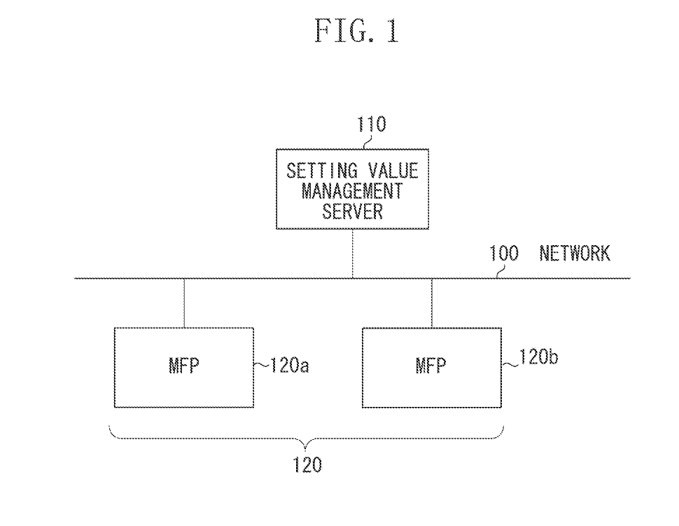

FIG. 1 is a block diagram illustrating a configuration of a system including a management apparatus and information processing apparatuses according to a first exemplary embodiment. In the present exemplary embodiment, a setting value management server 110, serving as the management apparatus, and multifunctional peripherals (MFPs) 120a and 120b, serving as the information processing apparatuses, are connected to a network 100. The information processing apparatus includes an image forming apparatus and a multifunction image forming apparatus.

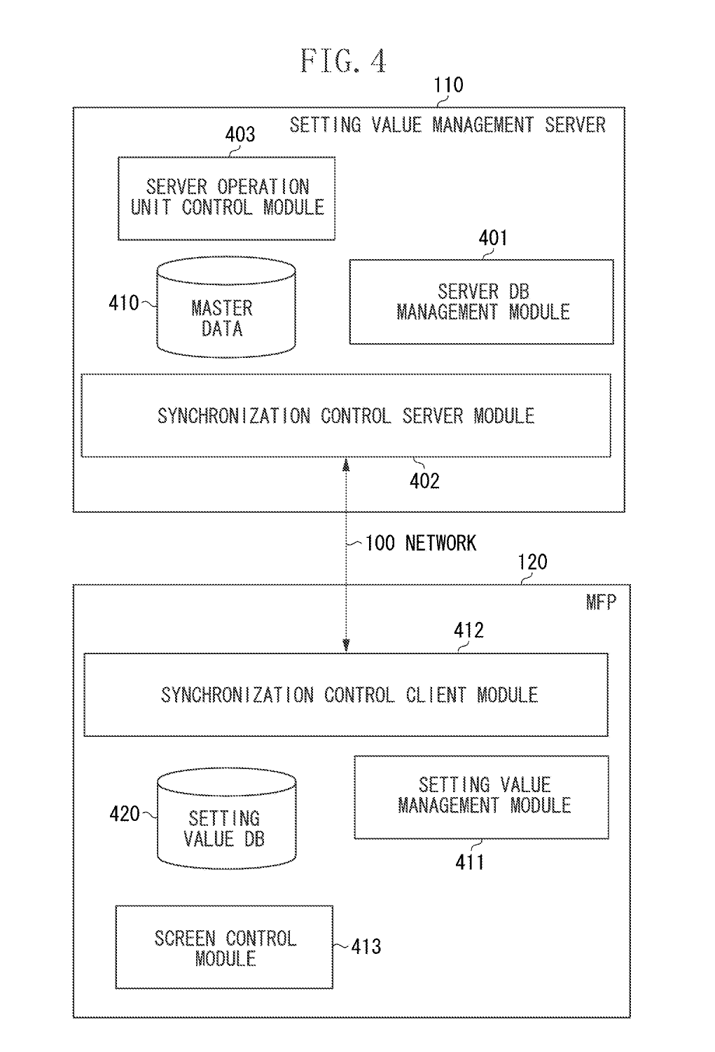

The setting value management server 110 illustrated in FIG. 1 registers master data 410 (FIG. 4) of setting values of the MFP 120a and the MFP 120b in a hard disk drive (HDD) 205 (described below), and manages the master data 410. When a change is made on the master data 410, the setting value management server 110 notifies the MFP 120a and the MFP 120b of change information through the network 100.

The setting value management server 110 changes a value in the master data 410 registered therein when receiving the change information about the setting value from the MFP 120a or the MFP 120b. The MFPs 120a and 120b execute a plurality of types of functions (copy, facsimile (FAX), and the like), and store therein the setting values used when the functions are executed. When a change is made on the setting value, the MFP 120a or 120b notifies the management server 110 of the change information through the network 100. The MFPs 120a and 120b change the setting value stored therein when receiving the change information about the master data 410 of the setting values from the setting value management server 110.

Some of the setting values are synchronized (in other words, shared) between a plurality of MFPs such as the MFP 120a and the MFP 120b. When a change is made on such setting values in the master data 410 on the setting value management server 110, both the MFP 120a and the MFP 120b are notified of the change information about the setting value. When the setting value of one of the MFP 120a and the MFP 120b is changed, the setting value management server 110 is first notified of the change information, and then the other one of the MFP 120a and the MFP 120b with the setting value unchanged is notified of the change information through the setting value management server 110. The setting value management server 110 and the MFPs 120a and 120b are described in detail below.

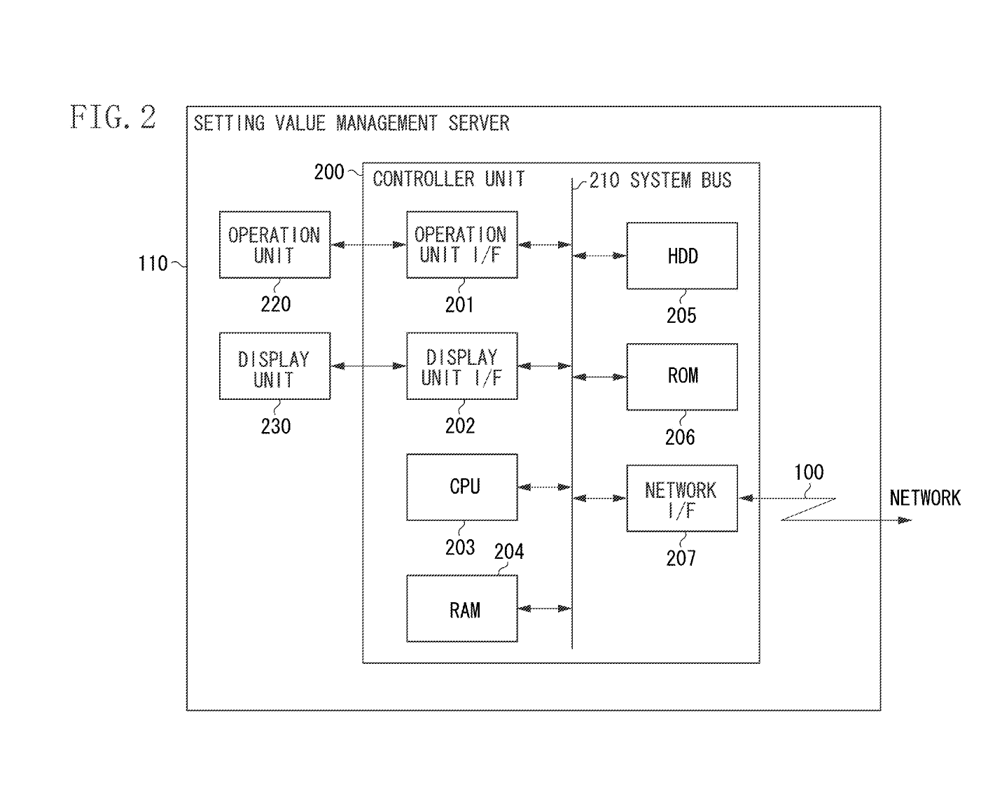

FIG. 2 is a block diagram illustrating a configuration of the setting value management server 110 illustrated in FIG. 1.

The setting value management server 110 illustrated in FIG. 2 includes a controller unit 200, an operation unit 220, and a display unit 230. The controller unit 200 includes a central processing unit (CPU) 203 that activates an operating system (OS) with a boot program stored in a read only memory (ROM) 206.

The CPU 203 executes an application program, stored in the HDD 205, on the OS, and thus executes various types of processing. The CPU 203 uses a random access memory (RAM) 204 as a work area. The HDD 205 stores the application program, the master data 410 of the setting values of the MFPs 120a and 120b, and the like. The ROM 206, the RAM 204, an operation unit interface (I/F) 201, a display unit I/F 202, and a Network I/F 207 are connected to the CPU 203 through a system bus 210.

The operation unit I/F 201 is an interface with the operation unit 220, including a mouse, keyboard, and the like, and transmits information, input by a user through the operation unit 220, to the CPU 203. The display unit I/F 202 outputs image data to be displayed on the display unit 230, including a display and the like, to the display unit 230. The Network I/F 207 is connected to the network 100 and inputs and outputs information to and from each apparatus on the network 100 through the network 100.

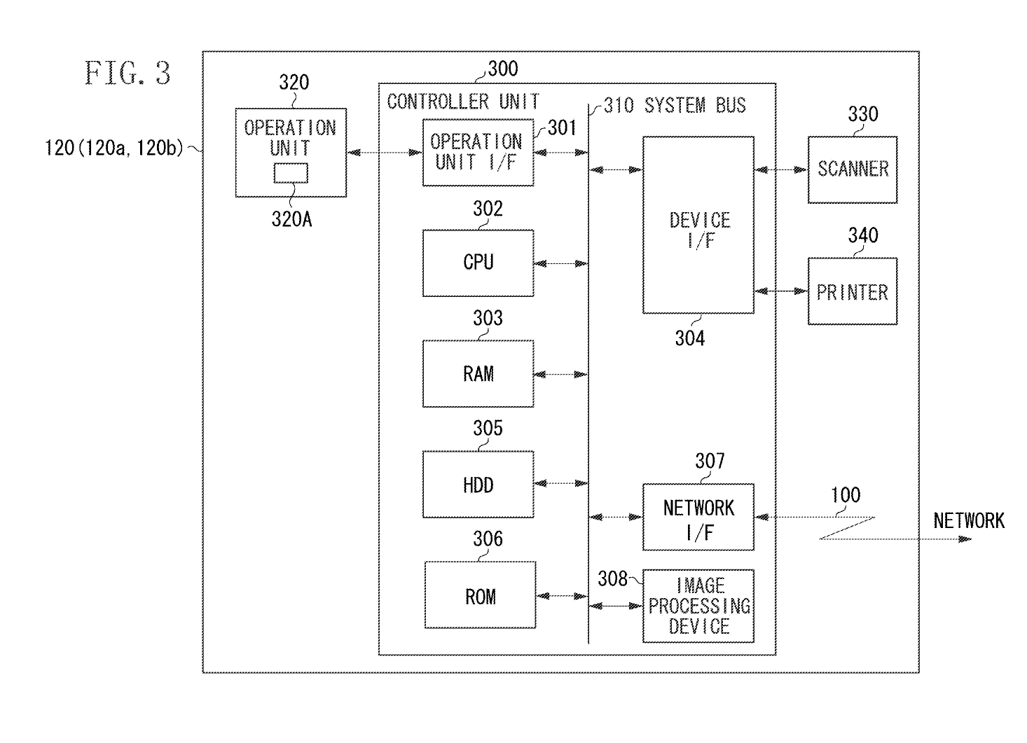

FIG. 3 is a block diagram illustrating a configuration of the MFPs 120a and 120b illustrated in FIG. 1 that are assumed to have the same block configuration and thus are collectively referred to as the MFP 120 as an example.

In FIG. 3, the MFP 120 includes a controller unit 300, an operation unit 320, a scanner 330, and a printer 340. The operation unit 320, the scanner 330 serving as an image input device, and the printer 340 serving as an image output device are connected to the controller unit 300.

The controller unit 300 includes a CPU 302 that starts an OS with a boot program stored in a ROM 306. The CPU 302 executes an application program stored in an HDD 305, on the OS, and thus executes various types of processing. The CPU 302 uses a RAM 303 as a work area.

The RAM 303 that provides the work area also provides an image memory area for temporarily storing the image data. The HDD 305 stores the application program, the image data, and various setting values. How the MFP 120 manages the setting values will be described below. The ROM 306, the RAM 303, an operation unit I/F 301, a device I/F 304, a Network I/F 307, and an image processing unit 308 are connected to the CPU 302 through a system bus 310. The operation unit I/F 301 is an interface with the operation unit 320 including a touch panel, and outputs image data, to be displayed on a display unit 320A of the operation unit 320, to the operation unit 320.

The operation unit I/F 301 transmits information input by the user through the operation unit 320 to the CPU 302. The device I/F 304 is connected to the scanner 330 and the printer 340, and performs synchronous/asynchronous conversion for the image data. The Network I/F 307 is connected to the network 100, and inputs and outputs information to and from each apparatus on the network 100, through the network 100. The image processing unit 308 executes various kinds of processing such as an image input processing from the scanner 330, an image output processing to the printer 340, image rotation processing, image compression processing, resolution conversion processing, color space conversion processing, and tone conversion processing.

FIG. 4 is a diagram illustrating an example of software configuration modules of the setting value management server 110 and the MFPs 120a and 120b illustrated in FIG. 1. In the present exemplary embodiment, the MFPs 120a and 120b are assumed to have the same software configuration and thus are collectively referred to as the MFP 120.

In FIG. 4, a server database (DB) management module 401 that edits data in the master data 410 is provided on a side of the setting value management server 110, and all the data is edited via the server DB management module 401. A web application that accesses the modules may be also provided, and browsing and data editing of the master data 410 may be performed through the web application.

A synchronization control server module 402 uses the network 100 to receive data acquisition and change requests from the MFP 120, serving as a client, and instructs the server DB management module 401 to perform reading and writing. A server operation unit control module 403 displays a screen on the display unit 230 by controlling the operation unit 220, so that a user operation can be received.

A setting value DB 420 is provided in the MFP 120. Writing and reading to and from the setting value DB 420 are performed through the setting value management module 411. The setting value DB 420 stores various types of setting data related to control of the MFP 120. Although not illustrated in FIG. 4, all the application programs that operate on the MFP 120 use the setting value management module 411 to access the setting value DB 420.

A synchronization control client module 412 communicates with the synchronization control server module 402 on the side of the setting value management server 110 through the network 100. A change made on the master data 410 on the side of the setting value management server 110, is retrieved, through periodical polling, to the side of the MFP 120 by the synchronization control client module 412 mainly. Furthermore, the synchronization control client module 412 performs an operation to reflect the update of the setting value DB 420, on the side of the MFP 120, on the master data 410, on the side of the setting value management server 110.

A series of operations including an operation of reflecting the change made on the setting value DB 420 on the master data 410 and an operation of detecting the change of the master data 410 and reflecting the change on the setting value DB 420 is recognized as synchronization control according to the present exemplary embodiment. With the synchronization (in other words, sharing) control, data can be synchronized between the setting value DBs 420 of the MFP 120a and the MFP 120b through the master data 410 of the setting value management server 110. A screen control module 413 displays a screen on the display unit 320A by controlling the operation unit 320, so that the user operation can be received.

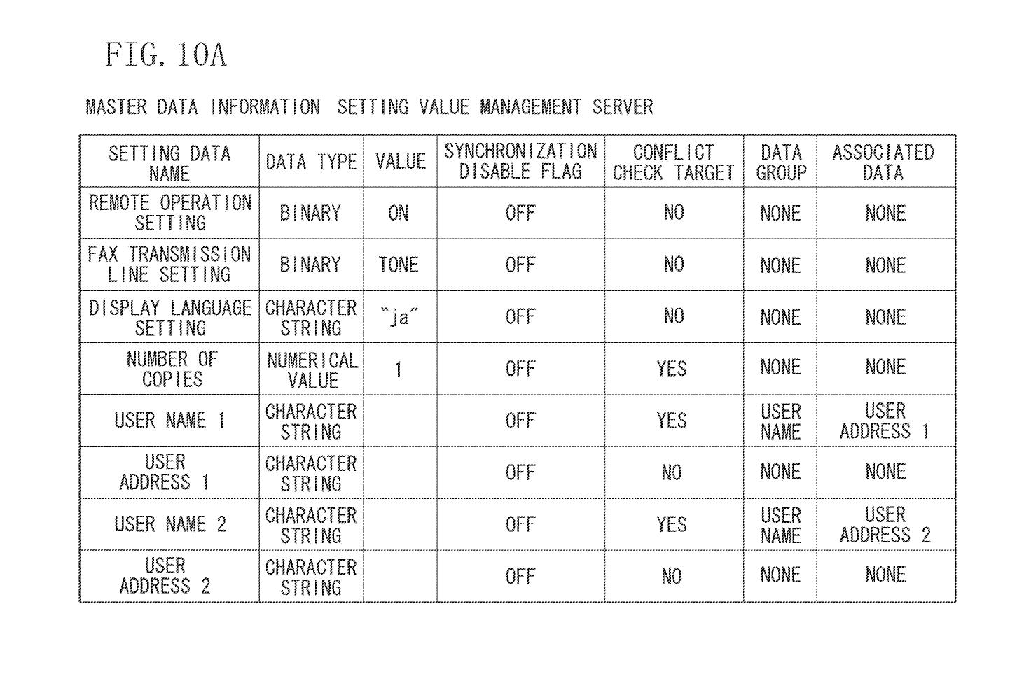

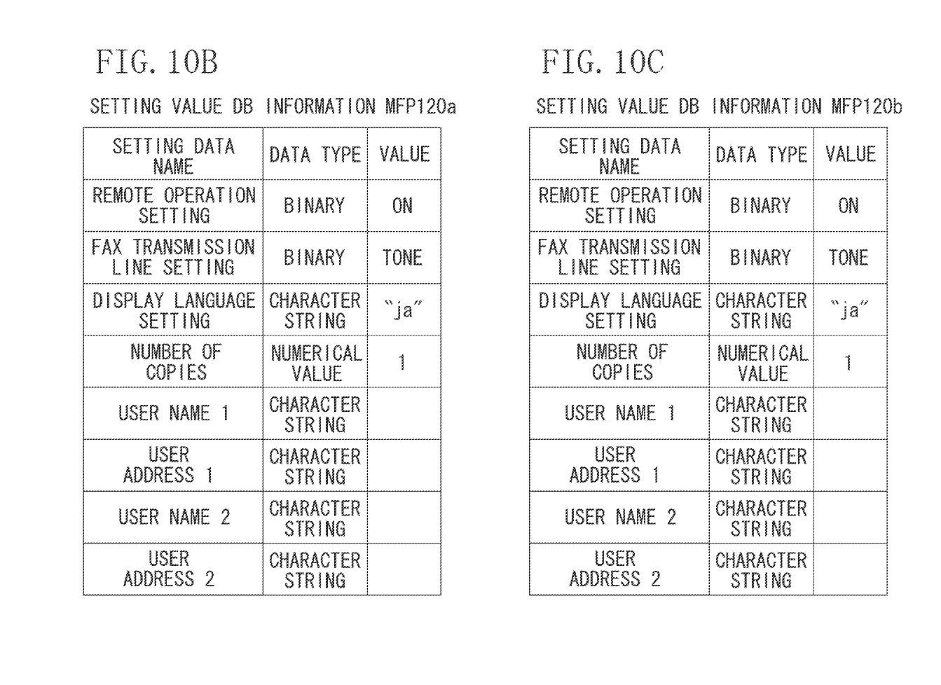

Next, the data in the master data 410 and in the setting value DB 420 is described with reference to FIGS. 10A to 10C.

First, an example of the data managed in the master data 410 is illustrated in FIG. 10A.

In FIG. 10A, “SETTING DATA NAME” indicates the name of setting data managed in the master data 410. “DATA TYPE” and “VALUE”, corresponding to each piece of setting data, are stored. For example, it is illustrated in the figure that “REMOTE OPERATION SETTING” is data of binary data type that is ON or “OFF”, and that the value is currently “ON”. A synchronization flag (“SYNCHRONIZATION DISABLE FLAG”) that is ON or OFF is management information for identifying whether the setting data synchronization between the master data 410 and the MFP 120 is disabled.

“CONFLICT CHECK TARGET”, which is one type of management information, indicates whether setting data is a target of checking, performed when the update request for the master data 410 is issued from a certain MFP 120, to see whether the update request for the same setting data has been issued from another MFP 120. “DATA GROUP” is management information indicating whether the setting data that is the conflict check target for which the update request has been issued is data to be checked for the conflict as a group. “DATA GROUP” contains information about a setting group of the setting data. “ASSOCIATED DATA” is information indicating setting data associated with certain setting data. The conflict check performed on setting data is further performed on the data associated thereto.

For example, setting data with “USER NAME 1” as SETTING DATA NAME has “YES” as CONFLICT CHECK TARGET and “USER NAME” as DATA GROUP. Setting data with “USER NAME 2” in the same data group “USER NAME” is also a target of conflict checking when the setting data with “USER NAME 1” is updated.

FIG. 10B illustrates setting data managed in the setting value DB 420 of the MFP 120a, and FIG. 10C illustrates setting data managed in the setting value DB 420 of the MFP 120b. “SETTING DATA NAME” is the name of the setting data managed in the setting value DB 420 and this setting data is managed with the same “SETTING DATA NAME” in the master data 410. “DATA TYPE” and “VALUE” corresponding to each piece of setting data are stored as in the case of the master data 410.

In the example illustrated in FIGS. 10B and 10C, the data is synchronized among the master data 410 and the setting value DBs 420 of the MFP 120a and the MFP 120b, thus the values of the setting data are the same among the master data 410 and the setting value DBs 420.

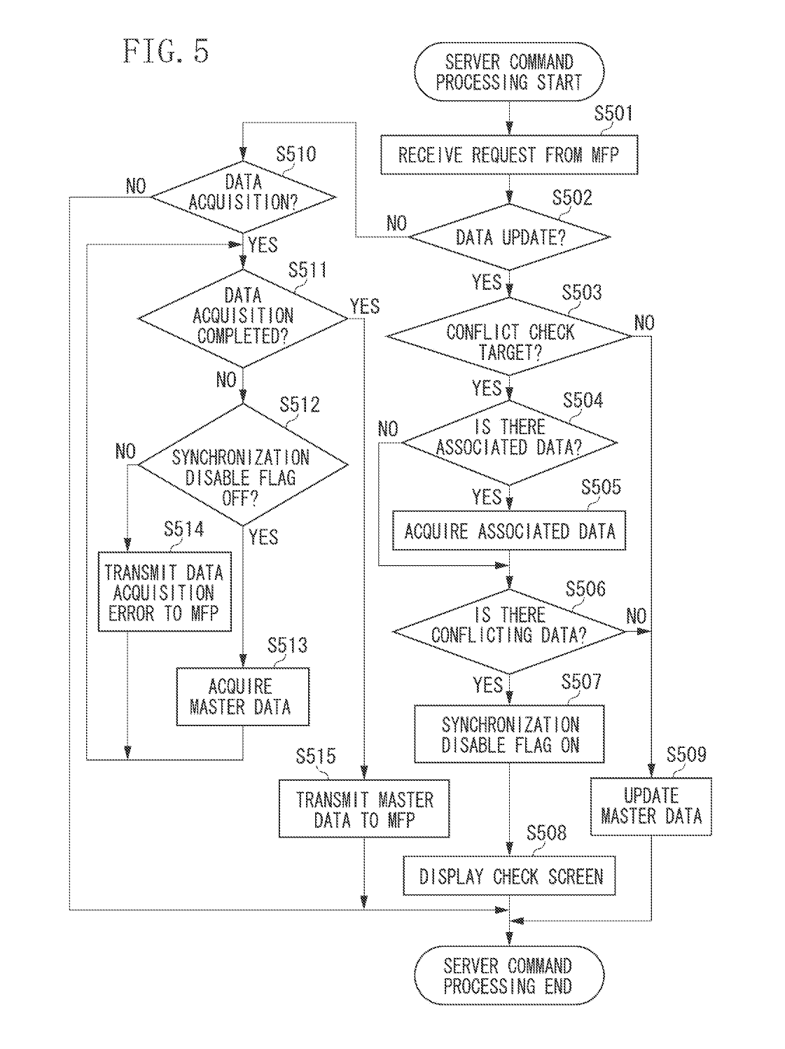

FIG. 5 is a flowchart illustrating a control method for the management apparatus according to the present exemplary embodiment. This example illustrates an example of setting data synchronization processing in the setting value management server 110 illustrated in FIG. 1. Each step is implemented when the CPU 203 executes a control program stored in the HDD 205. The modules illustrated in FIG. 4 are mainly described below. In step S501, the synchronization control server module 402 receives a data processing request from a certain MFP 120. This data processing request includes a data update request (synchronization request) for notifying the setting value management server 110 of the data update in the MFP 120 and data acquisition request for the MFP 120 to check with the setting value management server 110 whether the setting data has been changed.

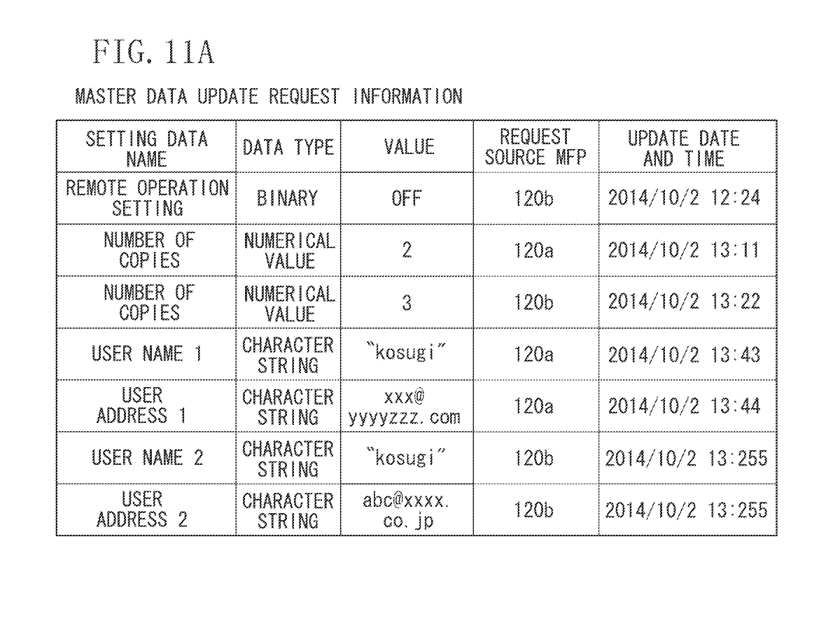

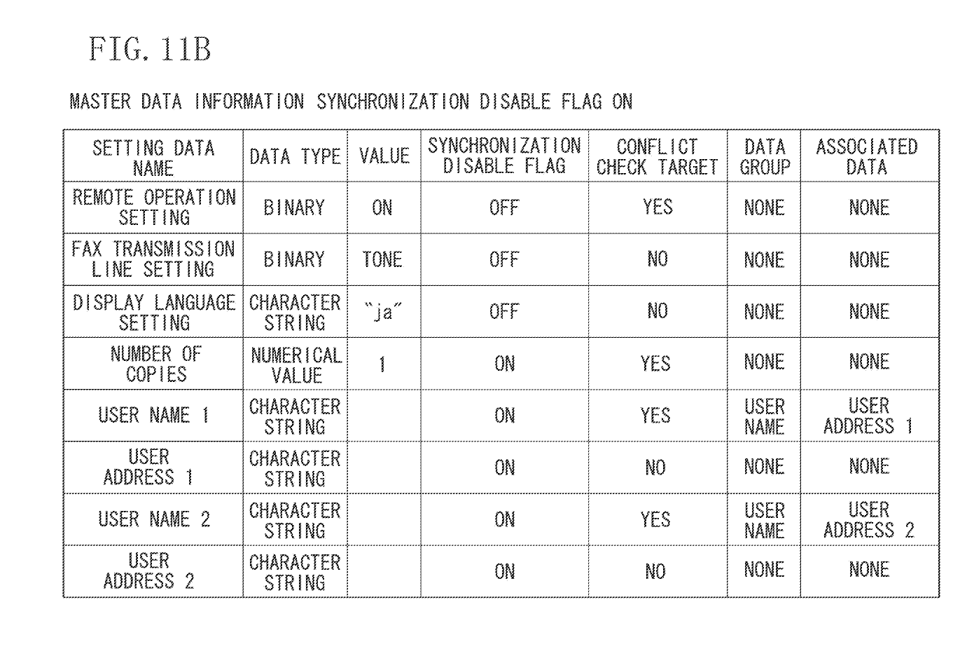

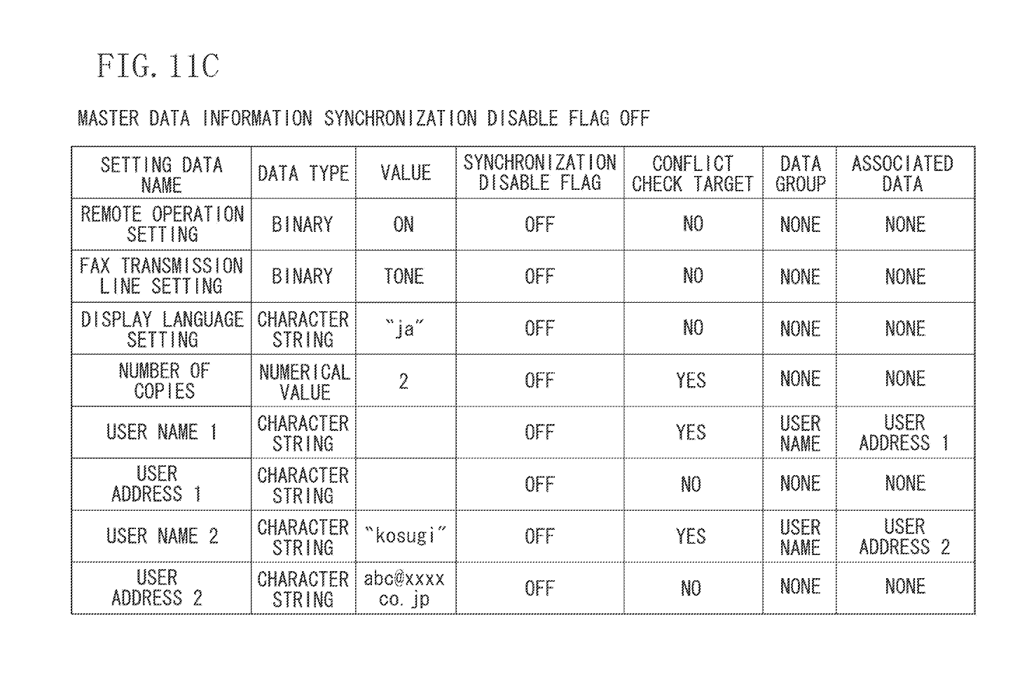

FIG. 11A illustrates an example of data update request information from the MFP 120. The data update request includes “SETTING DATA NAME” in FIG. 11A, indicating the setting data as a target of the data update request, “DATA TYPE”, “VALUE”, “DATA UPDATE REQUEST SOURCE”, “DATA UPDATE TIME”, and the like. For example, it can be seen in FIG. 11A that the MFP 120b was issued an update request for updating “REMOTE OPERATION SETTING” to change “VALUE” to “OFF” at date and time “2014/10/2 12:24”.

In step S502, the synchronization control server module 402 determines whether the data processing request is the data update request. At this time, when the synchronization control server module 402 determines that the data processing request is the data update request (YES in step S502), the processing proceeds to step S503. In step S503, the synchronization control server module 402 determines whether the setting data as the target of the data update request is the conflict check target based on “CONFLICT CHECK TARGET” illustrated in FIG. 10A. At this time, when the synchronization control server module 402 determines that the updated setting data is not the conflict check target (NO in step S503), the processing proceeds to step S509. In step S509, the server DB management module 401 updates the master data 410 with the setting data for which the data update request has been issued.

For example, “REMOTE OPERATION SETTING” in FIG. 11A is not the setting data that is the conflict check target as illustrated in FIG. 10A, and thus “REMOTE OPERATION SETTING” in the master data 410 is updated so that “VALUE” is changed to “OFF”.

In step S504, the synchronization control server module 402 determines whether there is data associated with the setting data as the target of the data update request, based on “DATA GROUP” and “ASSOCIATED DATA” illustrated in FIG. 10A. Here, the synchronization control server module 402 determines that there is the associated data (YES in step S504) when “DATA GROUP” and “ASSOCIATED DATA” are not “NONE”, and the processing proceeds to step S505. In step S505, the synchronization control server module 402 acquires the associated data.

For example, when “SETTING DATA NAME” is “USER NAME 1”, USER ADDRESS 1 associated with USER NAME 1 and information about USER NAME 2 in the same data group and USER ADDRESS 2 associated with USER NAME 2 are acquired.

Then, in step S506, the synchronization control server module 402 determines whether there is conflicting data. At this time, when the synchronization control server module 402 determines that there is no conflicting data update (NO in step S506), the processing proceeds to step S509. In step S509, the server DB management module 401 updates the master data 410 with the setting data for which the data update request has been issued.

In the example of NUMBER OF COPIES illustrated in FIG. 11A, the data update request for setting VALUE to “2” from the MFP 120a conflicts with the data update request for setting VALUE to “3” from the MFP 120b. Furthermore, in FIG. 11A, the MFP 120a and the MFP 120b have issued requests for changing USER NAME 1 and USER NAME 2 to the same user name “kosugi”, and thus the setting data change requests are conflicting.

Then, in step S507, the synchronization control server module 402 turns “ON” SYNCHRONIZATION DISABLE FLAG of the conflicting data and the associated data.

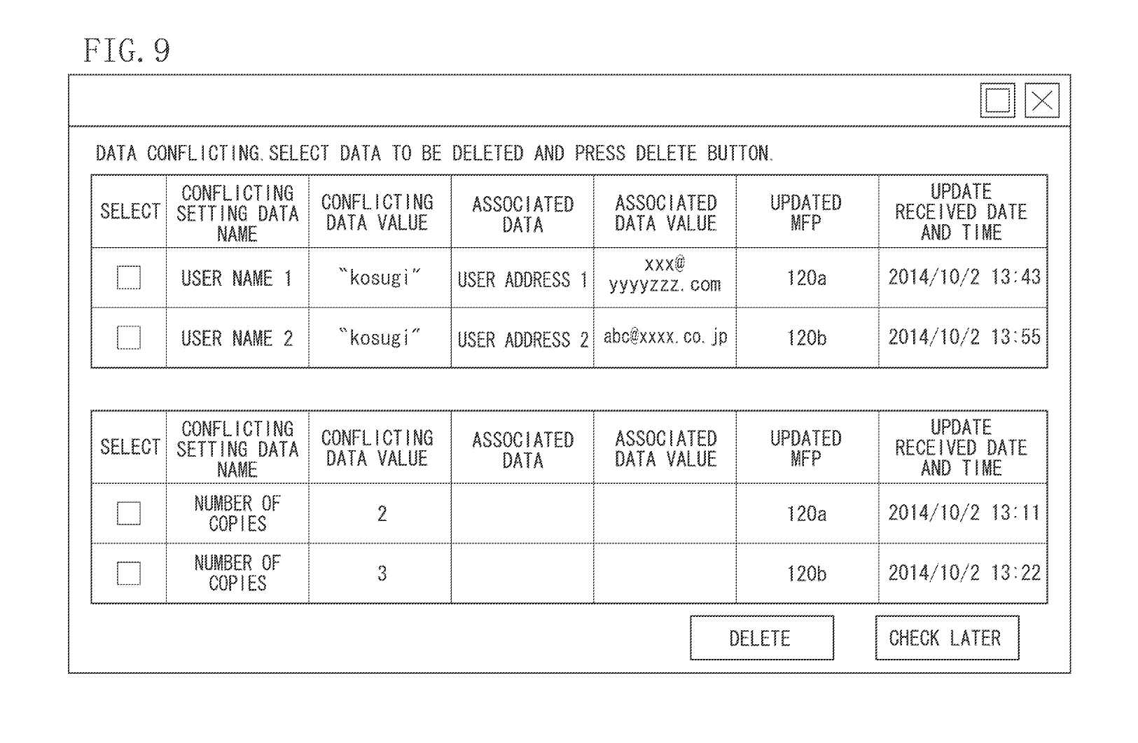

When it is determined that the data update requests for, for example, NUMBER OF COPIES, USER NAME 1, and USER NAME 2, are conflicting as illustrated in FIG. 11A, the synchronization control server module 402 requests the server operation unit control module 403 to display a conflicting data check screen (see FIG. 9). The server operation unit control module 403 performs the displaying on the display unit 230 through the operation unit 202 in step S508.

FIG. 9 is a diagram illustrating an example of a user interface (UI) screen displayed on the display unit 230 of the management apparatus. The UI screen corresponds to the conflicting data check screen.

In this example, SETTING DATA NAMEs involving the conflicting data update are listed so that the user can recognize the conflicting data.

FIG. 11B illustrates the master data 410 after the data update request in FIG. 11A is processed for the master data 410 illustrated in FIG. 10A.

When the CPU 203 determines that there is the conflicting data in step S506 (YES in step S506), SYNCHRONIZATION DISABLE FLAG is turned ON for the data update requests corresponding to NUMBER OF COPIES, USER NAME 1, and USER NAME 2, so that the requested data update is not reflected on the master data 410.

In step S502, when the synchronization control server module 402 determines that the data processing request is not the data update request (NO in step S502), the processing proceeds to step S510. In step S510, the synchronization control server module 402 determines whether the data processing request is the data acquisition request from the MFP 120. When the synchronization control server module 402 determines that the data processing request is the data acquisition request (YES in step S510), the processing proceeds to step S511. In step S511, the synchronization control server module 402 determines whether the data acquisition is completed. When the synchronization control server module 402 determines that the data acquisition is not completed (NO in step S511), the processing proceeds to step S512. In step S512, the synchronization control server module 402 determines whether SYNCHRONIZATION DISABLE FLAG corresponding to the setting data as the target of the acquisition request is OFF. When the synchronization control server module 402 determines that SYNCHRONIZATION DISABLE FLAG is OFF (YES in step S512), the processing proceeds to step S513. In step S513, the synchronization control server module 402 acquires setting data from the master data 410.

In step S512, when the synchronization control server module 402 determines that SYNCHRONIZATION DISABLE FLAG is ON (NO in step S512), the processing proceeds to step S514. In step S514, the synchronization control server module 402 transmits acquisition error to the MFP 120 as the data acquisition request source. When the data acquisition is completed (YES in step S511), the processing proceeds to step S515. In step S515, the synchronization control server module 402 transmits the acquired master data 410 to the MFP 120.

As described above, the data synchronization with the MFP 120 is disabled only for the setting data with SYNCHRONIZATION DISABLE FLAG turned “ON”, so that partial disabling of the setting data synchronization can be achieved.

In the processing example illustrated in FIG. 5, the setting value management server 110 responds to the request from the MFP 120. Alternatively, the setting value management server 110 may issue the request to the MFP 120 and execute similar processing.

In the processing example illustrated in FIG. 5, changes made on the setting data that are not the conflict check target are not subjected to the conflict check, and are used for updating the master data 410 in an order of the data update requests issued from the MFP 120. By thus limiting the setting data as the conflict check target, the processing load imposed on the setting value management server 110 can be reduced.

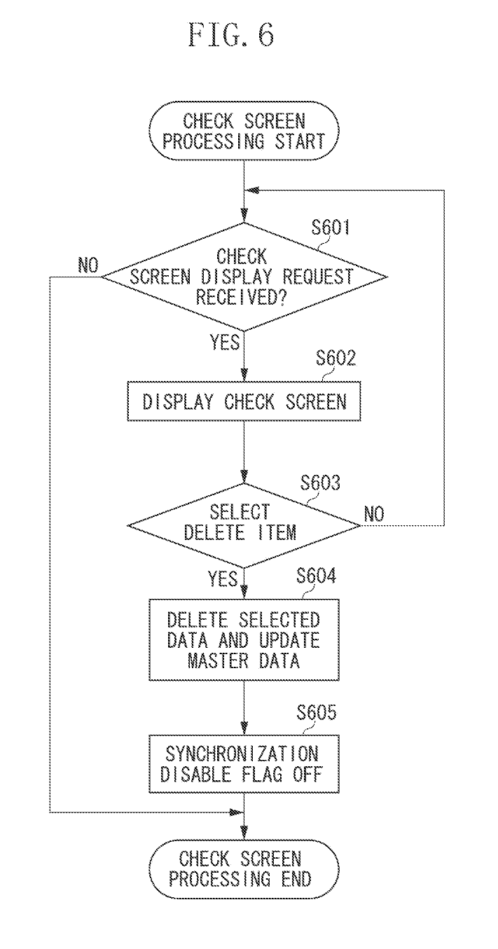

FIG. 6 is a flowchart illustrating a control method for the management apparatus according to the present exemplary embodiment. This example is an example of processing for controlling the check display screen in the server operation unit control module 403 as illustrated in FIG. 4. Each step is implemented when the CPU 203 executes a control program stored in the HDD 205. The modules illustrated in FIG. 4 will be mainly described below.

In step S601, the server operation unit control module 403 receives a check screen display request. Then, in step S602, the CPU 203 displays the check screen by using the UI screen illustrated in FIG. 9. An example of the UI screen illustrated in FIG. 9 is an example of a screen displayed on the display unit 230 of the operation unit 220.

In this example, in step S505, the server operation unit control module 403 displays the acquired associated data on the display unit 230 together with the setting data for which the conflict is detected. At this time, as the associated data is also displayed by the server operation unit control module 403, the user can recognize the conflicting data more in detail.

In step S603, the server operation unit control module 403 determines whether an item to be deleted is selected and a delete button is pressed. When the server operation unit control module 403 determines that the item to be deleted is selected and the delete button is pressed (YES in step S603), the processing proceeds to step S604. In step S604, the server operation unit control module 403 deletes the selected update data, and reflects the undeleted update data on the master data 410. Then, in step S605, the server operation unit control module 403 turns “OFF” SYNCHRONIZATION DISABLE FLAG, and the check screen display control is terminated.

FIG. 11C illustrates the master data 410 after SYNCHRONIZATION DISABLE FLAG that is ON in FIG. 11B is turned OFF as a result of processing in steps S603 to S605, and the undeleted update data is reflected thereon. In addition, FIG. 11C illustrates the master data 410 after the setting data is deleted in response to a deletion instruction issued with the delete button and the undeleted data is reflected thereon in step S603. More specifically, the setting data corresponding to “1” as VALUE of NUMBER OF COPIES that is one of a plurality of pieces of setting data with “ON” set as SYNCHRONIZATION DISABLE FLAG in FIG. 11B is deleted, and then SYNCHRONIZATION DISABLE FLAGs corresponding to USER NAME 1, USER ADDRESS 1, USER NAME 2, and USER ADDRESS 2 are turned “OFF”, so that the synchronization is enabled.

In the present exemplary embodiment, the setting data for which the conflicting setting data change is checked is limited in the setting value management server 110, and the data synchronization processing is disabled only for data associated with the setting data for which the conflict is detected. In this manner, the conflict check processing load for the setting data can be reduced, so that less influential data synchronization disabling can be achieved.

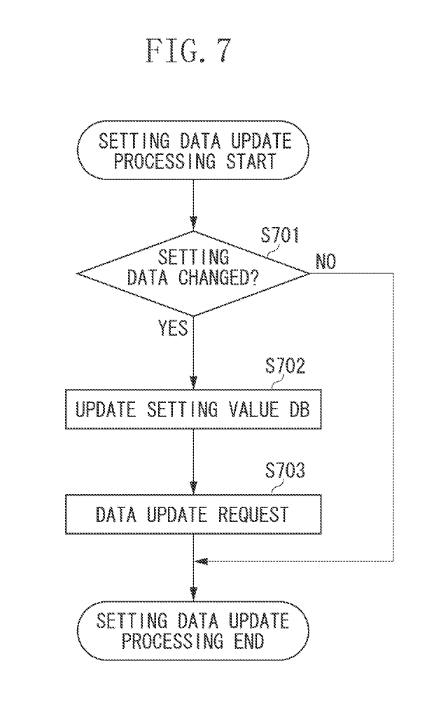

FIG. 7 is a flowchart illustrating a control method for the information processing apparatus according to the present exemplary embodiment. This example corresponds to an example of setting data update processing in the MFP 120 illustrated in FIG. 1. Each step is implemented when the CPU 302 of the MFP 120 executes a control program stored in the HDD 305. The modules illustrated in FIG. 4 will be mainly described below.

In step S701, when the setting value management module 411 determines that the setting data is changed (YES in step S701), the processing proceeds to step S702. In step S702, the setting value management module 411 updates the setting value DB 420. In step S703, the synchronization control client module 412 issues a data update request for the changed setting data to the setting value management server 110, and this processing is terminated.

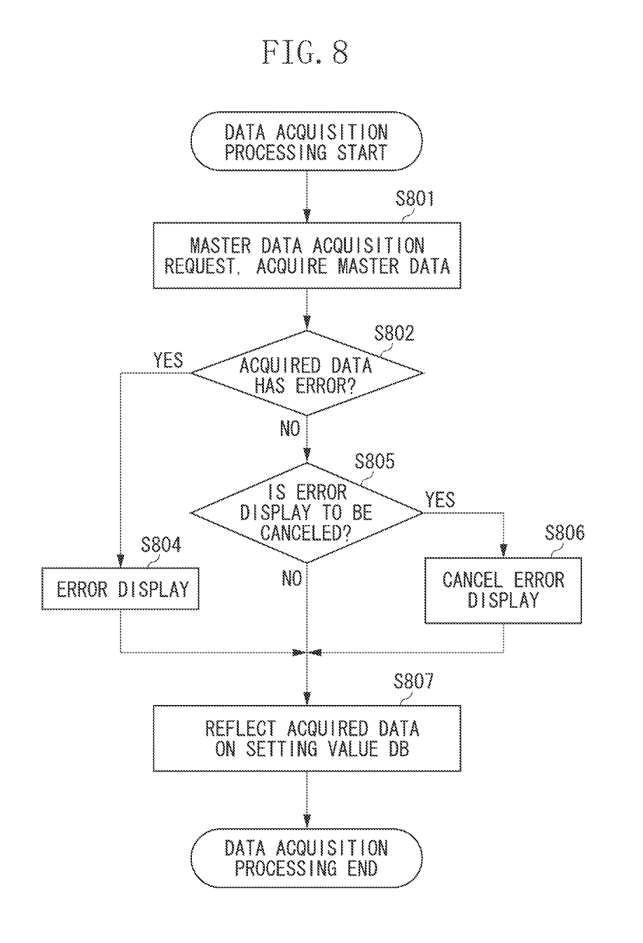

FIG. 8 is a flowchart illustrating a control method for the information processing apparatus according to the present exemplary embodiment. This example corresponds to an example of processing executed by the MFP 120 illustrated in FIG. 1 to acquire data from the setting value management server 110. Each step is implemented when the CPU 302 of the MFP 120 executes a control program stored in the HDD 305. The modules illustrated in FIG. 4 will be mainly described below.

In step S801, the synchronization control client module 412 issues a data acquisition request to the setting value management server 110 to acquires data. In step S802, the synchronization control client module 412 determines whether the acquired data has an error. When the synchronization control client module 412 determines that the acquired data has the error (YES in step S802), the processing proceeds to step S804. In step S804 the synchronization control client module 412 displays a message, indicating the data conflict for the setting data with the error, on the display unit 320A, and the processing proceeds to step S807.

In step S805, the synchronization control client module 412 determines whether an error display is to be canceled. More specifically, the synchronization control client module 412 determines that the error display is to be canceled when the acquired data has no error and the error display has been performed in step S804.

In step S805, the synchronization control client module 412 determines that the error display is to be canceled (YES in step S805), the processing proceeds to step S806. In step S806, the screen display module 413 cancels the error display. In step S807, the setting value management module 411 reflects the data, acquired by the synchronization control client module 412 from the setting value management server 110, on the setting value DB 420.

In the processing in FIGS. 7 and 8, the setting value management server 110 responds to a request from the MFP 120. Alternatively, the setting value management server 110 may issue a request to the MFP 120 and execute similar processing.

According to the present disclosure, a target of conflict determination processing is limited for setting data for which an update request is issued from each information processing apparatus. Therefore, a request for setting data that is not a target of the conflict determination processing can be received while efficiency of conflict determination processing is improved.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2015-002103, filed Jan. 8, 2015, which is hereby incorporated by reference herein in its entirety.

What is claimed is:

1. A management apparatus comprising:
a storage unit configured to store setting information to be used by an information processing apparatus;
a reception unit configured to receive a request for causing the storage unit to store the setting information to be used by the information processing apparatus;
a determination unit configure to determine, in a case where a setting item of first setting information, requested to be stored in the storage unit, is a setting item of a first type, whether a setting content of the first setting information conflicts with a setting content of second setting information stored in the storage unit; and
a control unit configured to perform control in such a manner that: (i) in a case where the setting item of the first setting information is a setting item of a second type different from the first type, the storage unit stores the first setting information regardless of whether the setting content of the first information conflicts with the setting content of the second setting information, (ii) in a case where the determination unit determines that the setting content of the first setting information conflicts with the setting content of the second setting information, storing of the first setting information as a share target in the storage unit is restricted, and (iii) in a case where the determination unit determines that the setting content of the first setting information does not conflict with the setting content of the second setting information, the storage unit stores the first setting information as the share target.

2. The management apparatus according to claim 1, further comprising a notification unit configured to notify another information processing apparatus, different from an information processing apparatus that has transmitted the request, of the setting information stored as the share target in the storage unit,
wherein the control unit is further configured to perform control in such a manner that in a case where the determination unit determines that the setting content of the first setting information conflicts with the setting content of the second setting information, the first setting information and the second setting information are stored in the storage unit as setting information that is not the share target.

3. The management apparatus according to claim 2, wherein the control unit manages whether the setting information stored in the storage unit is the share target using a flag.

4. The management apparatus according to claim 2, further comprising a display control unit configured to display on a display unit, a screen used by a user to select either one of the first setting information stored in the storage unit as setting information that is not the share target and the second setting information stored in the storage unit as the setting information that is not the share target, for setting information to be changed to the share target.

5. The management apparatus according to claim 2, wherein, in a case where the reception unit receives a request for updating or acquiring the setting information that is not the share target from the information processing apparatus, the notification unit is further configured to notify the information processing apparatus that has transmitted the request of an error.

6. The management apparatus according to claim 2, wherein, in a case where the reception unit receives a request for acquiring the setting information as the share target from the information processing apparatus, the notification unit is further configured to notify the information processing apparatus that has transmitted the request of the setting information as the share target.

7. The management apparatus according to claim 1, wherein the determination unit is further configured to determine whether third setting information, associated with the first setting information, conflicts with fourth setting information stored in the storage unit.

8. The management apparatus according to claim 4, wherein the control unit is further configured to delete setting data not selected on the screen by the user from the storage unit and change a state of information, for determining whether the setting information set in the setting data selected on the screen by the user is shared, into a sharing enabled state.

9. The management apparatus according to claim 1, wherein the storage unit is further configured to store the setting information in association with a data type, a value, a flag indicating a state of information for determining whether the setting information is shared, information indicating whether the setting information is a conflict check target, and associated data.

10. The management apparatus according to claim 1, wherein the setting item of the first type of the setting information includes at least one of a user name and a user address of the information processing apparatus.

11. The management apparatus according to claim 1, wherein the information processing apparatus is an image forming apparatus or a multifunction image forming apparatus.

12. A control method for a management apparatus, the method comprising:
storing, in a storage unit, setting information to be used by an information processing apparatus;
receiving a request for causing the storage unit to store the setting information to be used by the information processing apparatus;
determining, in a case where a setting item of first setting information, requested to be stored in the storage unit, is a setting item of a first type, whether a setting content of the first setting information conflicts with a setting content of second setting information stored in the storage unit; and
performing control in such a manner that: (i) in a case where the setting item of the first setting information is a setting item of a second type different from the first type, the storage unit stores the first setting information regardless of whether the setting content of the first information conflicts with the setting content of the second setting information, (ii) in a case where the setting content of the first setting information is determined to conflict with the setting content of the second setting information in the determining, storing of the first setting information as a share target in the storage unit is restricted, and (iii) in a case where the setting content of the first setting information is determined not to conflict with the setting content of the second setting information in the determining, the storage unit stores the first setting information as the share target.

13. The control method according to claim 12, further comprising notifying another information processing apparatus, different from an information processing apparatus that has transmitted the request, of the setting information stored as the share target in the storage unit,
wherein, in the performing control, control is performed in such a manner that, in a case where it is determined that the setting content of the first setting information conflicts with the setting content of the second setting information in the determining, the first setting information and the second setting information are stored in the storage unit as setting information that is not the share target.

14. A non-transitory computer-readable storage medium storing a program causing a computer to execute a method, the method comprising:
storing, in a storage unit, setting information to be used by an information processing apparatus;
receiving a request for causing the storage unit to store the setting information to be used by the information processing apparatus;
determining, in a case where a setting item of first setting information, requested to be stored in the storage unit, is a setting item of a first type, whether a setting content of the first setting information conflicts with a setting content of second setting information stored in the storage unit; and
performing control in such a manner that: (i) in a case where the setting item of the first setting information is a setting item of a second type different from the first type, the storage unit stores the first setting information regardless of whether the setting content of the first information conflicts with the setting content of the second setting information, (ii) in a case where it is determined that the setting content of the first setting information conflicts with the setting content of the second setting information in the determining, storing of the first setting information as a share target in the storage unit is restricted, and (iii) in a case where it is determined that the setting content of the first setting information does not conflict with the setting content of the second setting information in the determining, the storage unit stores the first setting information as the share target.

15. The storage medium according to claim 14,
wherein the program further causes the computer to execute notifying another information processing apparatus, different from an information processing apparatus that has transmitted the request, of the setting information stored as the share target in the storage unit,
wherein, in the performing control, control is performed in such a manner that, in a case where it is determined that the setting content of the first setting information conflicts with the setting content of the second setting information in the determining, the first setting information and the second setting information are stored in the storage unit as setting information that is not the share target.
